(19) United States
(12) Patent Application Publication
(10) Pub. No.: US 2006/0137714 A1
(43) Pub. Date: Jun. 29, 2006

(54) Apparatus for removing edge bead in plating process for fabricating semiconductor device

(75) Inventor: Ji Ho Hong, Suwon city (KR)

Correspondence Address: THE LAW OFFICES OF ANDREW D. FORTNEY, PH.D., P.C., 7257 N. MAPLE AVENUE, BLDG. D, SUITE 107, FRESNO, CA, 93720, US

(73) Assignee: DongbuAnam Semiconductor Inc.

(21) Appl. No.: 11/302,061

(22) Filed: Dec. 12, 2005

(30) Foreign Application Priority Data
Dec. 23, 2004 (KR) 10-2004-0111159

(51) Int. Cl. C23G 1/00; B08B 7/00; B08B 3/00; C03C 23/00

(52) U.S. Cl. 134/2; 134/137; 134/149; 134/198; 134/34; 134/33

(57) ABSTRACT

An apparatus for removing an edge bead in, e.g., a plating process for fabricating a semiconductor device is provided, by which a wafer surface may be prevented from being oxidized by a chemical used in an edge bead removal (EBR) process. The apparatus may includes a spin chuck; a wafer on the spin chuck having a metal layer thereon; a nozzle for spraying a chemical on an edge of the wafer; and a cover shield having a bent (or curved) portion opposing a lateral side of the wafer. Accordingly, the bent or curved portion of the sidewall of the cover shield prevents or reduces the incidence of back splash of the chemical spun off the wafer in EBR process, thereby preventing or reducing the occurrence of defects such as the stripe pattern (or other surface oxidation) due to the wafer's contact with the chemical other than at the edge.

This application claims the benefit of Korean Patent Application No. 10-2004-0111159, filed on Dec. 23, 2004, which is hereby incorporated by reference as if fully set forth herein.

### BACKGROUND OF THE INVENTION

1. Field of the Invention

The present invention relates to an apparatus for fabricating a semiconductor device, and more particularly, to an apparatus for removing an edge bead in a plating process in the fabrication of a semiconductor device. Although the present invention is suitable for a wide scope of applications, it is particularly suitable for preventing oxidation of a wafer surface due to chemical substances used in an edge bead removal process of a wafer after completion of the plating process.

2. Discussion of the Related Art

A plating process for fabricating a semiconductor device includes the steps of electrochemical plating, edge bead removal, rinsing, and drying. The electrochemical plating is carried out, prior to patterning, to form a metal layer from which lines on a circuit board or integrated circuit will be formed and/or to fill a wafer feature, e.g., a via or a contact hole, with a metal layer. In doing so, a seed layer formed on a substrate (wafer) is submerged, together with an anode, in an electrolyte of an electrolyte cell, and a bias voltage is applied to the seed layer, taking the anode as a reference, to induce metal to be deposited on the seed layer through the electrolyte, thereby forming (plating) the seed layer with the metal layer. The seed layer is electrically biased. Such a process is required for forming copper (Cu) lines implemented by the damascene process, by which small holes and trenches are realized as a damascene pattern and then filled with the aforementioned metal layer.

Edge bead removal (EBR) is carried out after completion of the above electrochemical plating, to remove an edge bead that may be formed on a wafer and to prevent peeling and the like that may occur in subsequent processing due to excessive stress occurring at the wafer edges. The wafer is then cleaned (rinsed) and dried.

FIG. 1 illustrates a plating process of a semiconductor device according to a related art, in which a metal layer 30 is formed on a wafer 20 on which a seed layer 22 has been formed thereon by electrochemical plating. An edge bead on an edge 24 of the wafer 20 having the metal layer 30 is removed by an EBR process. Subsequently, the wafer 20, from which the edge bead has been removed, is cleaned by a rinsing process and then dried by a drying process to complete the plating process.

Referring to FIG. 2, an edge bead removal (EBR) device according to a related art comprises a spin chuck 10, a wafer 20 on the spin chuck 10, a nozzle 40 for spraying an EBR chemical 42 on an edge area of the wafer 20, and a cover shield 50 for covering the wafer 20 to prevent splashing the sprayed EBR chemical. The spin chuck 10 enables the wafer 20 to be turned by a rotational force transferred from a drive shaft 12 connected to a driver (not shown). A metal layer 30 is formed on the wafer 20 by electrochemical plating. The wafer 20 is carried by a conveyer (not shown) to be loaded on the spin chuck 10. The nozzle 40 sprays the EBR chemical 42 supplied from an EBR chemical tank (not shown) on one edge area of the wafer 20. The cover shield 50 is installed to cover a topside and lateral side of the wafer 20, to prevent the EBR chemical 42 sprayed on the wafer 20 from being externally splashed and contaminating peripheral devices (e.g., on the wafer) by the rotation of the wafer 20. In this case, both sidewalls of the cover shield 50 opposing the lateral sides or edges of the wafer 20 are configured in a vertical column shape.

In an EBR device configured as above, once the wafer 20 is loaded on the spin chuck 10, the wafer 20 is turned to remove an edge bead from the edge area of the wafer 20 using the EBR chemical sprayed on the edge area. In this case, however, the EBR chemical 42 may collide with the sidewall of the cover shield 50, as shown in FIG. 3, by a centrifugal force generated from the rotation of the wafer 20, and the chemical 42 rotationally ejected from the wafer 20 may then be splashed back (from the cover shield) onto a surface of the wafer 20, whereby the metal layer 30 on the wafer 20 can be oxidized by the splashed EBR chemical. As shown in FIG. 4, streaks of oxidization 34 can occur on the metal layer 30 after the edge bead 24 has been removed from the wafer 20 by the EBR process. Such streaks may remain even after rinsing and drying.

### SUMMARY OF THE INVENTION

Accordingly, the present invention is directed to an apparatus for removing an edge bead in a plating process for fabricating a semiconductor device that substantially obviates one or more problems due to limitations and disadvantages of the related art.

An object of the present invention is to provide an apparatus for removing an edge bead in a plating process, by which a surface (e.g., the plated surface) of a wafer is prevented from being oxidized or streaked by a chemical used in an edge bead removal (EBR) process on the wafer after plating.

Additional advantages, objects, and features of the invention will be set forth in part in the description which follows and in part will become apparent to those skilled in the art upon examination of the following or may be learned from practice of the invention. The objectives and other advantages of the invention may be realized and attained by the structure(s) and/or process(es) particularly pointed out in the written description and claims hereof as well as the appended drawings.

To achieve these objects and other advantages in accordance with the purpose of the invention, as embodied and broadly described herein, there is provided an apparatus for removing an edge bead in a plating process, the apparatus comprising a spin chuck adapted to hold a wafer or other substrate (which may have a metal layer thereon), a nozzle configured to spray a chemical on an edge of a wafer or substrate, and a cover shield having a bent portion opposing a lateral side or edge of the wafer or substrate to cover the wafer. The metal payer may comprise a plated metal layer. The invention enjoys particular advantage in an apparatus for removing an edge bead from a wafer having a plurality of semiconductor devices thereon and/or in a process for fabricating semiconductor devices.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of a plating process of a semiconductor device according to a related art;

FIG. 2 is a diagram of an EBR device according to the related art;

FIG. 3 is a diagram of the area A shown in FIG. 2;

FIG. 4 is a perspective diagram of a wafer exhibiting streaking caused by the chemical back splash shown in FIG. 3;

FIG. 5 is a diagram of an apparatus for removing an edge bead of a plating process according to the present invention; and

FIGS. 6 and 7 are each diagrams of the area B shown in FIG. 5, illustrating a cover shield according to exemplary embodiments of the present invention.

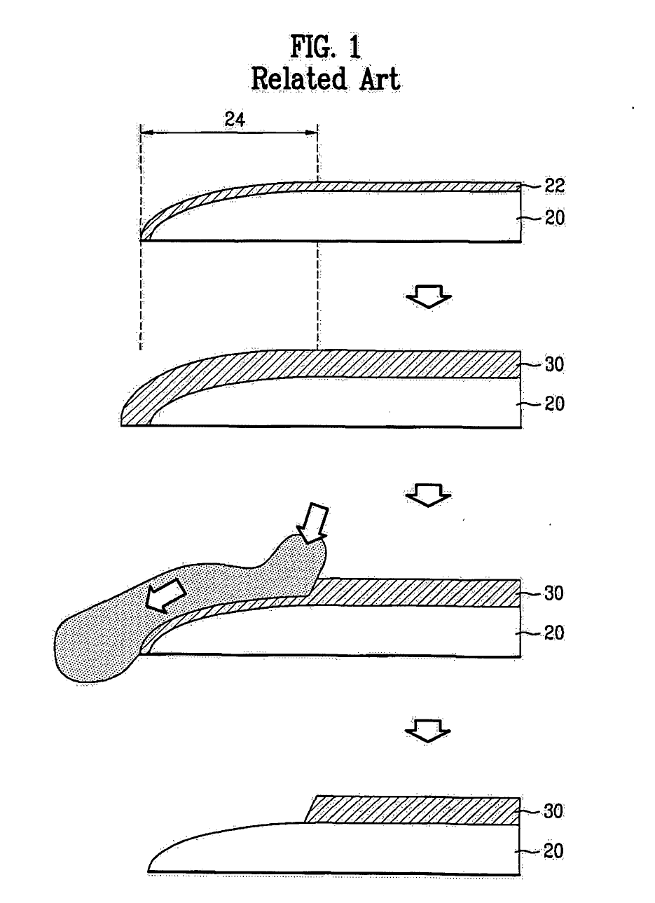

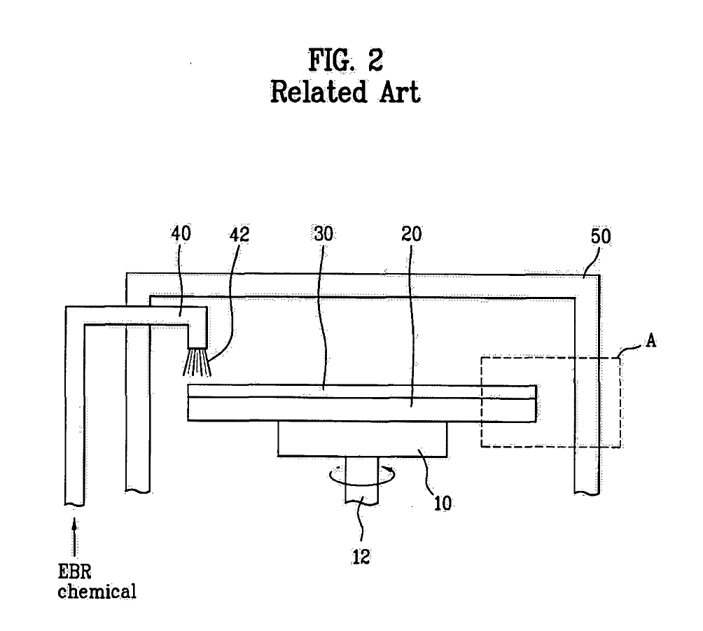

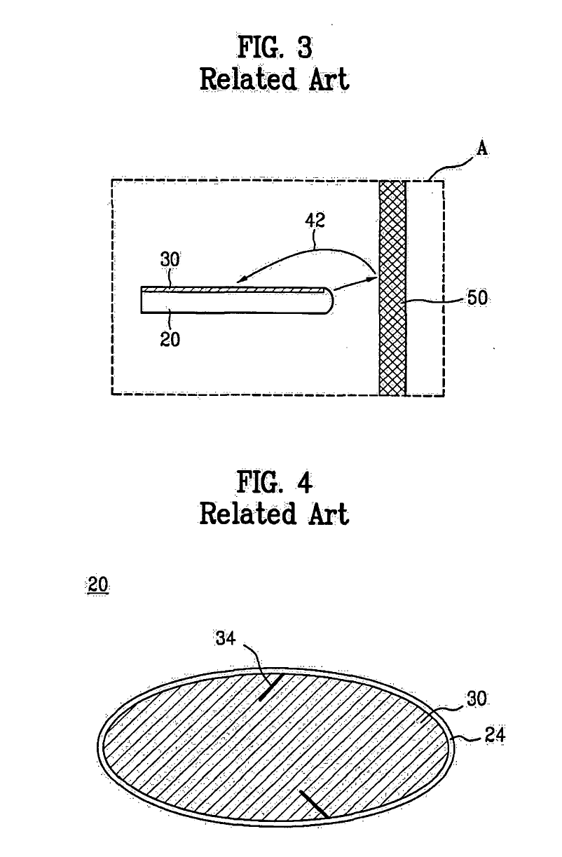

### DETAILED DESCRIPTION OF THE INVENTION

Reference will now be made in detail to the preferred embodiments of the present invention, examples of which are illustrated in the accompanying drawings. Wherever possible, like reference designations will be used throughout the drawings to refer to the same or similar parts.

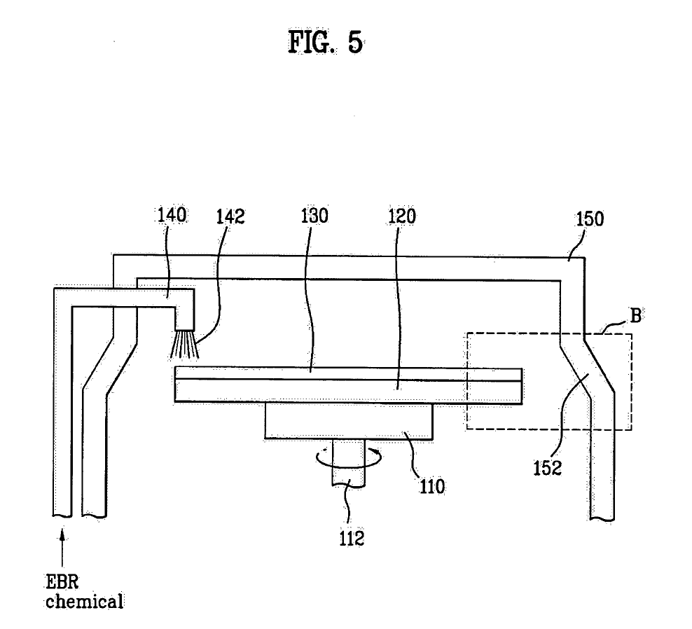

Referring to FIG. 5, an apparatus for removing an edge bead of a plating process for fabricating a semiconductor device according to an embodiment of the present invention includes a spin chuck 110, a wafer 120 on the spin chuck 110, a nozzle 140 for spraying an EBR chemical 142 on an edge area of the wafer 120, and a cover shield 150 for covering the wafer 120. The cover shield 150 of the present invention includes a bent or oblique sidewall portion 152 to prevent the EBR chemical 142 sprayed on the wafer 120 from being externally splashed or sprayed by a centrifugal force of the wafer 120 and to prevent the chemical 142 from being splashed back to the wafer 120.

The spin chuck 110 enables the wafer 120 to be turned by a rotational force transferred from a drive shaft 112 connected to a driver (not shown). A metal layer 130 is formed on the wafer 120 by, e.g., electrochemical plating. In this case, the metal layer 130 may be formed of a copper-based material. However, the metal layer 130 may be formed by any conventional metal-layer forming method (e.g., evaporation, a physical vapor deposition [PVD] method such as sputtering, chemical vapor deposition [CVD], etc.), and may comprise any conventionally used metal (e.g., aluminum, titanium, tungsten, etc.). The wafer 120 is carried by a conveyer (not shown) and is loaded on the spin chuck 110. The nozzle 140 sprays the EBR chemical 142 supplied from an EBR chemical tank (not shown) on one edge area of the wafer 120.

The cover shield 150 is installed to cover a topside and lateral side of the wafer 120 to prevent the EBR chemical 142 sprayed on the wafer 120 from being externally splashed, sprayed or scattered to contaminate peripheral devices by the rotation of the wafer 120. In this case, both sidewalls of the cover shield 150 configure a vertical column. The vertical column of the cover shield 150 includes the bent portion 152, which is bent from a portion opposing or perpendicular to the lateral side (or edge) of the wafer 120, in a direction opposite to (e.g., at an oblique angle away from) the lateral side (or edge) of the wafer 120. The angle of bent portion 152 relative to the upper surface of the wafer 120 (or metal layer 130) may be from 15° to 80°, from about 40° to about 70°, or from about 45° to about 60°. Further, the bent portion 152 may have an upper endpoint about 5 to 100 mm (alternatively, 10 to 80 mm, or 15 to 60 mm) above the upper surface of the wafer 120 (or metal layer 130), and/or it may have an lower endpoint even with or about 1 to 30 mm (alternatively, 1 to 20 mm, or 1 to 10 mm) below the lower surface of the wafer 120.

The bent portion 152 of the cover shield 150 is tilted from the portion opposing the lateral side of the wafer 120 at a prescribed angle in the direction opposite (or away from) to the lateral side of the wafer 120 and is then vertically bent back to a vertical position (e.g., perpendicular to a horizontal wafer 120) below the upper surface of the wafer 130. Since the bent portion 152 of the cover shield 150 is tilted at the prescribed angle, the EBR chemical 142 (or a relatively greater portion thereof in comparison to an identical cover shield having vertical sidewalls) splashed from or spun off the wafer 120 by the centrifugal force generated from the rotation of the wafer 120 in performing the EBR process on the wafer 120 can be splashed not back to the surface of the wafer 120, but rather, to a lower part of the cover shield 150. Namely, the bent portion 152 of the cover shield 150 prevents or reduces the likelihood of the EBR chemical 142 splashed from the wafer 120 from being splashed back onto the surface of the wafer 120.

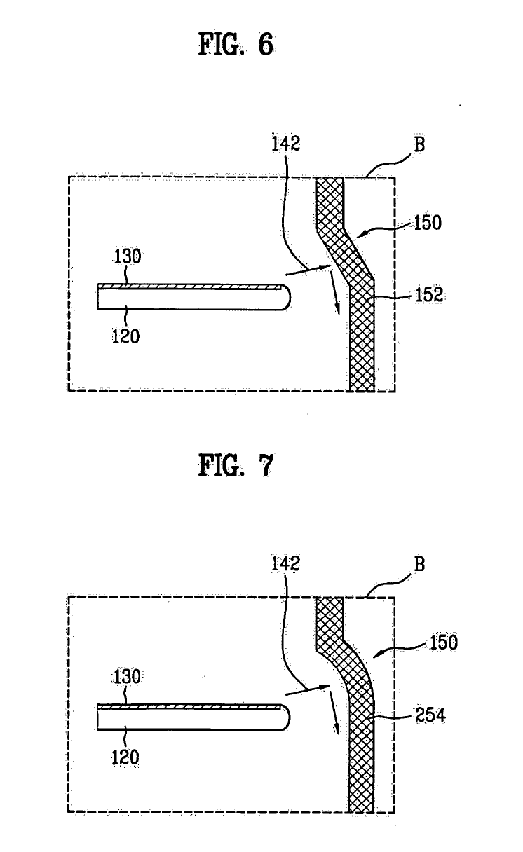

In the EBR apparatus according to the present invention, once the wafer 120 is loaded on the spin chuck 110, the wafer 120 is turned, spun or rotated to remove an edge bead from the edge area of the wafer 120 as the EBR chemical is sprayed or directed onto the edge area of the wafer 120. In doing so, the back-splash phenomenon is prevented or minimized by the bent portion 152 of the cover shield 150, as shown in FIG. 6. Namely, the EBR chemical 142, which has collided with the sidewall of the cover shield 150 by the centrifugal force of the rotation of the wafer 120, is prevented from being splashed back to the surface of the wafer 120. Hence, the EBR apparatus according to present invention, which prevents or reduced the likelihood of the EBR chemical 142 from being splashed back to the surface of the wafer 120 from the sidewall of the cover shield 150 during the EBR process, can also prevent or reduce the occurrence of the strip pattern (e.g., pattern 34 in FIG. 4) on the metal layer 130 of the wafer 120.

As shown in FIG. 7, in the EBR apparatus according to the present invention, the cover shield 150 may alternatively include a curved portion 154, curved from a part of the vertical column opposing the lateral side (or edge) of the wafer 120 in a direction opposite to (or away from) the lateral side of the wafer 120. The curved portion 154 of the cover shield 150 is rounded from the part opposing the lateral side of the wafer 120 (or thereabove) in the direction opposite to or away from the lateral side of the wafer 120. The curved portion 154 may have a prescribed curvature, and the cover shield 150 may then be vertical below the bent (curved) portion 154. The arc of curved portion 154 may be from 5° to 45°, from about 10° to about 40°, or from about 15° to about 35°. Further, similar to bent portion 152, the curved portion 154 may have an upper endpoint about 5 to 100 mm (alternatively, 10 to 80 mm, or 15 to 60 mm) above the upper surface of the wafer 120 (or metal layer 130), and/or it may have an lower endpoint even with or about 1 to 30 mm (alternatively, 1 to 20 mm, or 1 to 10 mm) below the lower surface of the wafer 120.

Since the curved portion 154 of the cover shield 150 is rounded to have the prescribed curvature, the EBR chemical 142 splashed from the wafer 120 by the centrifugal force of the rotation of the wafer 120 is generally splashed not back to the surface of the wafer 120, but rather, to a lower side of the cover shield 150 during the EBR process. Namely, the curved portion 154 of the cover shield 150 prevents or reduces the likelihood of the EBR chemical 142 centrifugally spun from the wafer 120 from being splashed back to the surface of the wafer 120.

Accordingly, by the bent or curved portion of the sidewall of the cover shield opposing the lateral side of the wafer, the present invention can prevent, reduce or minimize the back splash of the chemical from the wafer during EBR on the edge area of the wafer. Hence, the occurrence of the stripe pattern, generated from the oxidation of the surface of the wafer due to the chemical back splash, may be reduced or prevented, thereby raising the throughput of the semiconductor device (or its corresponding manufacturing process) and/or the manufacturing process yield, and facilitating defect management accordingly.

It will be apparent to those skilled in the art that various modifications can be made in the present invention without departing from the spirit or scope of the invention. Thus, it is intended that the present invention covers such modifications provided they come within the scope of the appended claims and their equivalents.

What is claimed is:

1. An apparatus for removing an edge bead in a plating process, comprising:
a spin chuck;
a substrate on the spin chuck having a plated metal layer thereon;
a nozzle configured to spray a chemical on an edge of the substrate; and
a cover shield having a bent portion opposing a lateral side of the wafer, configured to cover the wafer.

2. The apparatus of claim 1, wherein the bent portion is bent in a direction opposite to the lateral side of the wafer.

3. The apparatus of claim 1, wherein the bent portion comprises a tilted, substantially linear surface.

4. The apparatus of claim 1, wherein the bent portion comprises a curved surface.

5. The apparatus of claim 1, wherein the metal layer comprises a copper-based material.

6. The apparatus of claim 1, the cover shield comprising:
a sidewall for encircling the loaded wafer.

7. The apparatus of claim 6, wherein the sidewall is substantially vertical, except for the bent portion.

8. The apparatus of claim 6, wherein the bent portion of the cover shield occurs along a portion of the sidewall corresponding to a height of the loaded wafer.

9. An apparatus for removing an edge bead from a metal layer on a semiconductor device, comprising:
a spin chuck configured to hold and spin a wafer;
a nozzle configured to spray a chemical on an edge of the wafer; and
a cover shield having a sidewall adapted to encircle the wafer, the sidewall having a bent portion in a portion thereof corresponding to a horizontal height of the wafer.

10. The apparatus of claim 9, wherein the bent portion of the cover shield has a prescribed angle.

11. The apparatus of claim 9, wherein, when the wafer is spun on the spin chuck, the bent portion directs the chemical from the edge of the wafer downward.

12. The apparatus of claim 9, wherein the bent portion has an upper endpoint no more than 100 mm above the horizontal height of the wafer, and a lower endpoint no more than 10 mm below the horizontal height of the wafer.

13. The apparatus of claim 9, wherein the bent portion comprises a curved portion having an arc.

14. A method of removing an edge bead from a wafer having a metal layer on its upper surface, comprising:
mounting the wafer on a spin chuck in an apparatus configured to remove the edge bead;
covering or encircling the wafer with a cover shield having a bent portion opposing an edge of the wafer;
spraying a chemical adapted to remove the edge bead onto an edge of the substrate; and
spinning the wafer.

15. The method of claim 14, wherein the bent portion of the cover shield has a prescribed angle.

16. The method of claim 14, further comprising directing the chemical spun off the edge of the wafer downward.
